(19) United States
(12) Patent Application Publication
(10) Pub. No.: US 2020/0228433 A1
(43) Pub. Date: Jul. 16, 2020

(54) COMPUTER-READABLE RECORDING MEDIUM INCLUDING MONITORING PROGRAM, PROGRAMMABLE DEVICE, AND MONITORING METHOD

(71) Applicant: FUJITSU LIMITED, Kawasaki-shi (JP)

(72) Inventor: Chunghan Lee, Yokohama (JP)

(73) Assignee: FUJITSU LIMITED, Kawasaki-shi (JP)

(21) Appl. No.: 16/733,839

(22) Filed: Jan. 3, 2020

(30) Foreign Application Priority Data
Jan. 15, 2019 (JP) 2019-004501

(51) Int. Cl. H04L 12/26; H04L 29/06; H04L 29/08

(52) U.S. Cl. CPC H04L 43/18; H04L 67/16; H04L 69/162

(57) ABSTRACT

A program, when executed by a processor coupled to a first memory, causes the processor to: store, when a flag which is added to duplicate information including a transmission source and destination addresses of a received packet, the flag in a first area in the first memory, update a value of a counter indicating an access frequency to duplicate-information included in a second area at the first memory for each processing according to the received-packet, execute processing in the second area corresponding to each flag in the first area accumulated at a first timing, refer to the second area for each processing at a second timing, and move an entry in the second area from the first memory to a second memory provided at a subsequent stage of the first memory when the updated value of the counter is equal to or greater than a threshold.

### CROSS-REFERENCE TO RELATED APPLICATION

This application is based upon and claims the benefit of priority of the prior Japanese Patent Application No. 2019-4501, filed on Jan. 15, 2019, the entire contents of which are incorporated herein by reference.

### FIELD

The embodiments discussed herein are related to a computer-readable recording medium including a monitoring program, a programmable device, and a monitoring method.

### BACKGROUND

In a microservice, one application is independently deployed and the microservice may be easily changed and a scale-out may be also easily performed by coupling the respective applications.

Japanese Laid-open Patent Publication No. 2018-120489, Japanese Laid-open Patent Publication No. 2003-218872, and Japanese Laid-open Patent Publication No. 2018-81440 are examples of related art.

### SUMMARY

According to an aspect of the embodiments, a non-transitory computer-readable recording medium includes a monitoring program which, when executed by a processor coupled to a first memory and a second memory, causes the processor to: store, when a flag which is added to duplicate information including a transmission source address and a transmission destination address of a received packet and which indicates processing to the received packet is the specific flag, the flag in a first area in the first memory, update a value of a counter indicating an access frequency to duplicate information included in a second area at the first memory for each processing according to the received packet, execute processing in the second area corresponding to each flag in the first area accumulated at a first timing, refer to the second area for each processing at a second timing, and move an entry in the second area from the first memory to the second memory provided at a subsequent stage of the first memory when the updated value of the counter is equal to or greater than a threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a scale-out of a monolith architecture according to a related example;

FIG. 2 is a diagram illustrating a scale-out of a microservice architecture according to a related example;

FIG. 3 is a diagram for explaining processing in a distributed tracing system according to a related example;

FIG. 4 is a diagram for explaining a processing time in a distributed tracing system according to a related example;

FIG. 5 is a diagram for explaining an HTTP cookie-based stateful maintenance method according to a related example;

FIG. 6 is a diagram for explaining a token-based stateful maintenance method according to a related example;

FIG. 7 is a diagram for explaining communication between microservices according to a related example;

FIG. 8 is a diagram illustrating a configuration example of a programmable device according to a related example;

FIG. 9 is a diagram illustrating a memory architecture of a programmable device according to a related example;

FIG. 10 is a diagram for explaining a flow tracking in a container-based sidecar according to a related example;

FIG. 11 is a diagram for exemplifying a communication tracing table according to a related example;

FIG. 12 is a table for explaining a resource saving method for a local memory according to a related example;

FIG. 13 is a sequence diagram for explaining a method for estimating Span ID according to a related example;

FIG. 14 is a table for explaining a method for estimating Span ID according to a related example;

FIG. 15 is a block diagram illustrating a configuration example of a programmable device according to an example of an embodiment;

FIG. 16 is a diagram for explaining an outline of memory latency reduction processing according to an example of an embodiment;

FIG. 17 is a sequence diagram for explaining an outline of memory latency reduction processing illustrated in FIG. 16;

FIG. 18 is a sequence diagram for explaining an outline of memory latency reduction processing illustrated in FIG. 16;

FIG. 19 is a table illustrating a duplicate information pool according to an example of an embodiment;

FIG. 20 is a table illustrating a definition of Match flag according to an example of an embodiment;

FIG. 21 is a table illustrating a first example of duplicate information according to an example of an embodiment;

FIG. 22 is a table illustrating a second example of duplicate information according to an example of an embodiment;

FIG. 23 is a table illustrating details of a duplicate information pool according to an example of an embodiment;

FIG. 24 is a diagram illustrating details of a duplication management table according to an example of an embodiment;

FIG. 25 is a diagram illustrating a span table according to an example of an embodiment;

FIG. 26 is a block diagram illustrating a functional configuration example of a programmable device according to an example of an embodiment;

FIG. 27 is a diagram for explaining entry insertion processing in a programmable device according to an example of an embodiment;

FIG. 28 is a sequence diagram for explaining entry insertion processing in a programmable device according to an example of an embodiment;

FIG. 29 is a sequence diagram for explaining entry insertion processing in a programmable device according to an example of an embodiment;

FIG. 30 is a diagram for explaining entry deletion processing in a programmable device according to an example of an embodiment;

FIG. 31 is a sequence diagram for explaining entry deletion processing in a programmable device according to an example of an embodiment;

FIG. 32 is a flowchart for explaining processing in an access measurement time slot of a programmable device according to an example of an embodiment;

FIG. 33 is a flowchart for explaining processing in a penalty management time slot of a programmable device according to an example of an embodiment;

FIG. 34 is a flowchart for explaining processing in a penalty management time slot of a programmable device according to an example of an embodiment; and

FIG. 35 is a flowchart for explaining time slot management processing in a programmable device according to an example of an embodiment.

### DESCRIPTION OF EMBODIMENTS

For example, when monitoring services configured with microservices, it is assumed that the flow is tracked with a sidecar (Sidecar) used in a container-based distributed system, but a lot of memory space and central processing unit (CPU) are consumed.

Therefore, it is assumed that tracking is performed by a programmable device that may include a network interface card (NIC) or a switch.

However, since there is a limitation in a local memory that the programmable device is able to use, the amount of memory used is required to be reduced.

Thus, it is assumed that communication information that is various common items is subjected to hash to generate a key, and the information is accumulated for each key.

Hereinafter, an embodiment will be described with reference to the drawings. However, the embodiment described below is merely an example, and there is no intention to exclude application of various modifications and techniques not explicitly described in the embodiment. For example, the embodiment may be implemented with various modifications without departing from the spirit of the embodiment.

Each drawing is not intended to include only the components illustrated in the drawings, and may include other functions.

Hereinafter, in the drawings, the same reference signs indicate the same parts, and the description thereof is omitted.

### RELATED EXAMPLE

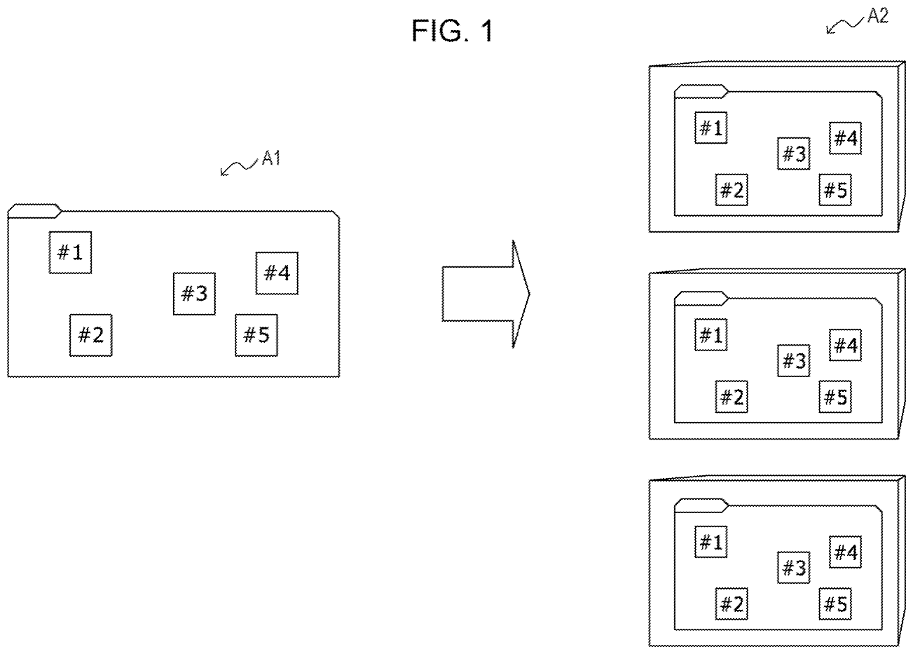

FIG. 1 is a diagram illustrating a scale-out of a monolith architecture in a related example.

The monolith architecture is a monolithic architecture, and a plurality of functions are constructed as one execution body (refer to reference sign A1). In the illustrated example, services #1 to #5 function in the monolith architecture.

When scaling out the monolith architecture, the entire application is replicated to a plurality of servers (refer to reference sign A2).

In the monolith architecture, many applications operate in one server and virtual machine, it is sometimes not easy to change or scale out.

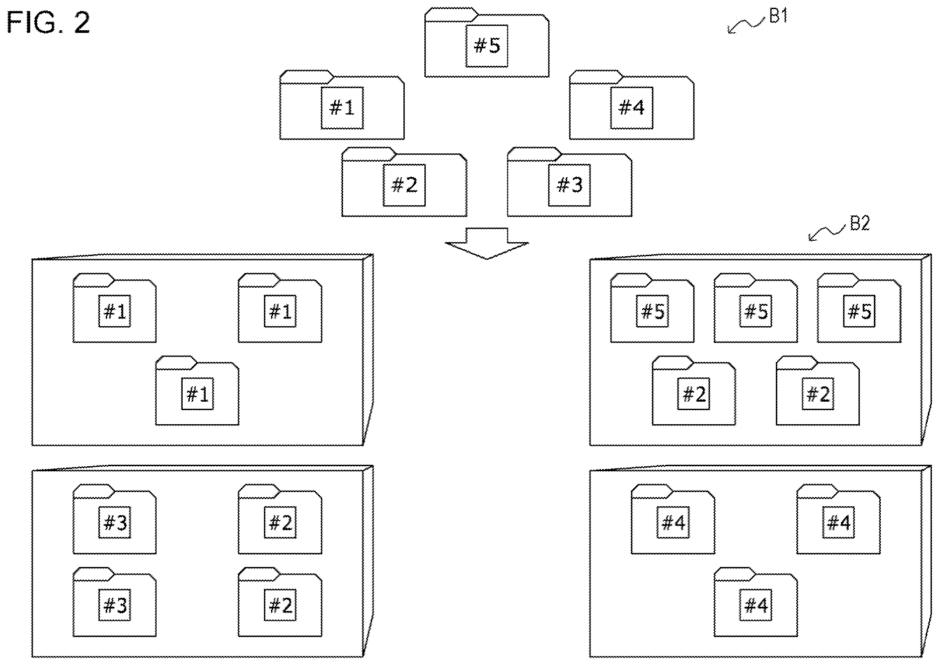

FIG. 2 is a diagram illustrating a scale-out of a microservice architecture in the related example.

In the microservice architecture, each service is constructed as a single highly independent business mechanism (refer to reference sign B1). In the illustrated example, services #1 to #5 function in the monolith architecture.

When scaling out the microservice architecture, each service is disposed in a plurality of servers as required (refer to reference sign B2).

In the microservice architecture, since each application is independently deployed, change and scale-out are easily performed.

However, since the microservice architecture is a kind of distributed system, monitoring may not be easy to implement.

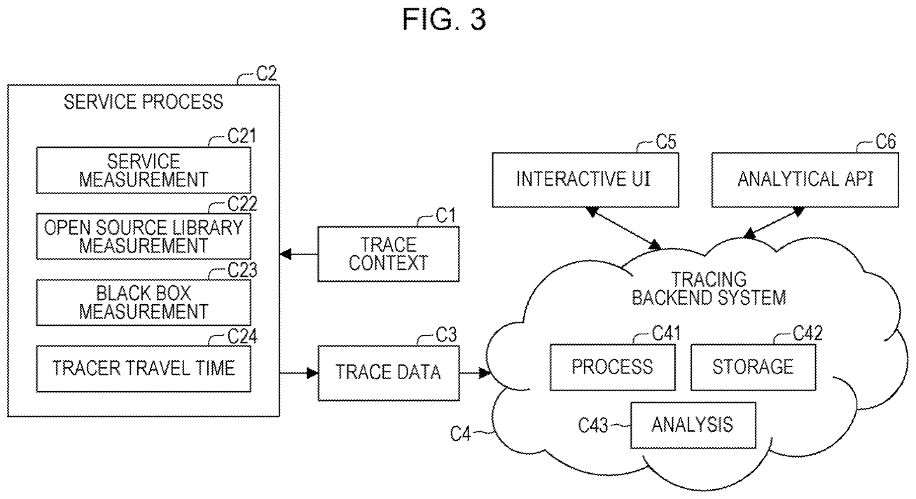

FIG. 3 is a diagram for explaining processing in a distributed tracing system in the related example.

The distributed tracing system detects an error or a slow query generated in the application and presents a state in the application. The distributed tracing system also traces and records transactions in the application. The distributed tracing system performs monitoring and performance analysis of the system. An additional container called Sidecar (Proxy) is deployed for performing tracing.

In the example illustrated in FIG. 3, a trace context as a recording transaction is given to a service processor (refer to reference sign C1).

The service processor performs service measurement, open source library measurement, and black box measurement respectively indicated by reference signs C21 to C23 as the described transactions (refer to reference sign C2).

The service processor calculates a tracer travel time (refer to reference sign C24) and transmits it as trace data to a tracing back-end system (refer to reference sign C3).

In the tracing back-end system, the process, storage, and analysis respectively indicated by reference signs C41 to C43 are functioned (refer to reference sign C4).

The tracing back-end provides an interactive UI and an analytical API as analysis transactions (refer to reference signs C5 and C6). UI is an abbreviation for a user interface, and API is an abbreviation for an application programming interface.

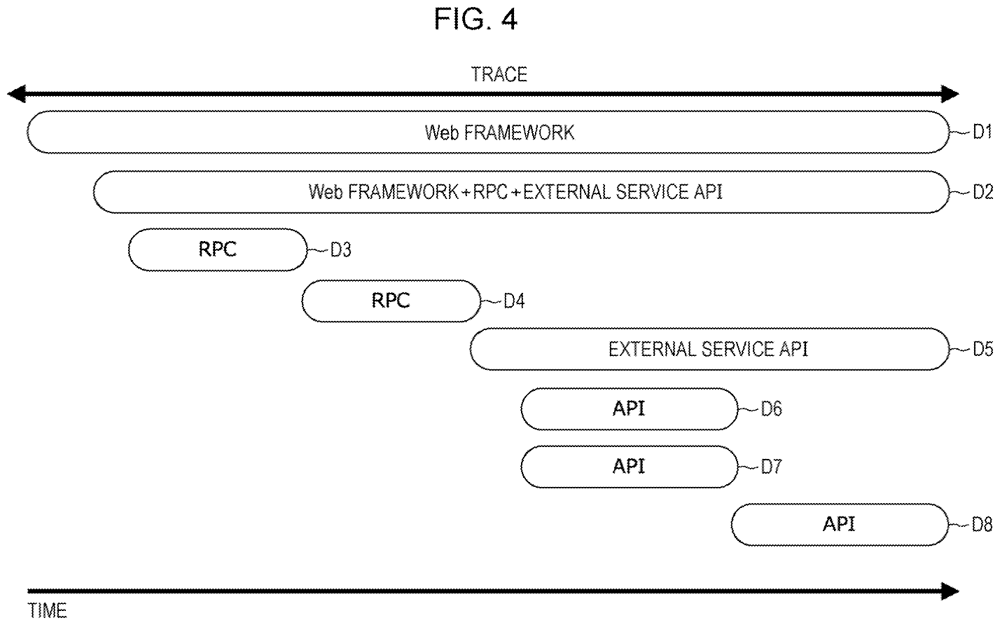

FIG. 4 is a diagram for explaining a processing time in a distributed tracing system in the related example.

A set of spans from the start to the end in the distributed tracing is called a trace. In the example illustrated in FIG. 4, the web framework indicated by reference sign D1 is a trace. A set of the web framework, a remote procedure call (RPC), and an external service API indicated by reference sign D2 is a span. The RPC, the external service, and the API indicated by reference signs D3 to D8 are also spans.

The span is a logical unit in the distributed system, and defines a name, a work start time, a work time, and the like. Each span may have a relationship between a parent as a calling source and a child as a calling destination.

The distributed tracing system monitors performance degradation based on the first and last calling times of the span. When the span is extended, the processing time of the microservice increases. In the illustrated example, the API of the external service indicated by reference sign D5 requires more processing time than the RPC indicated by reference sign D4.

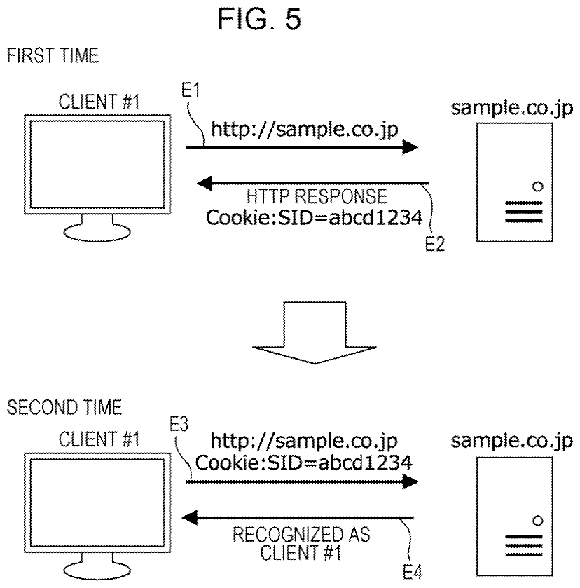

FIG. 5 is a diagram for explaining an HTTP cookie-based stateful maintenance method in the related example.

In the first processing, a client #1 accesses a server of “sample.co.jp” (refer to reference sign E1).

By this, the server generates abcd1234 as a session identifier (SID), and stores the session ID and the information of the client #1 in association with each other.

The server transmits SID=abcd1234 as a cookie to the client #1 in a Hypertext Transfer Protocol (HTTP) response (refer to reference sign E2).

By this, a browser of the client stores the cookie SID abcd1234.

In the second processing, the client #1 transmits SID=abcd1234 stored in the browser to the server when accessing the server of “sample.co.jp”, (refer to reference sign E3).

By this, the server obtains the information of the client #1 stored by SID=abcd1234, and recognizes the coupling source as the client #1 (refer to reference sign E4).

From the above, it is possible to treat the information of the same client #1 in separate communications of the first time and the second time.

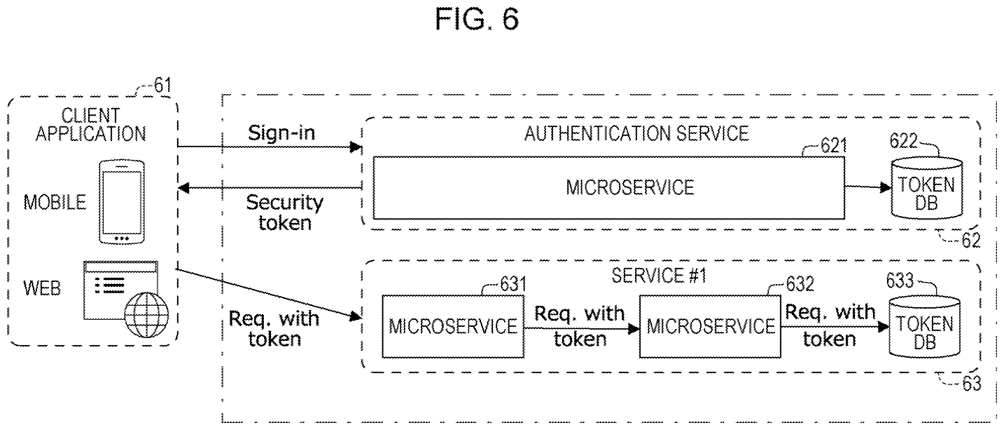

FIG. 6 is a diagram for explaining a token-based stateful maintenance method in the related example.

The microservices may recognize each other's resources by embedding a token when transmitting a request/response to each other. Token-based HTTP authentication is defined in request for comments (RFC) 7617 and is a standard track. When referring to a virtual infrastructure (also referred to as “resource”) in an open stack, the token is issued with a keystone, and each resource is referenced with the API.

In the example illustrated in FIG. 6, a client application 61 such as a mobile or web signs-in to the authentication service 62. The microservice 621 in the authentication service 62 issues a security token to the client application 61 by referring to the token database (DB) 622.

The client application 61 issues a request to a service 63 together with the token. The microservice 631 in the service 63 accesses the token DB 633 via the microservice 632.

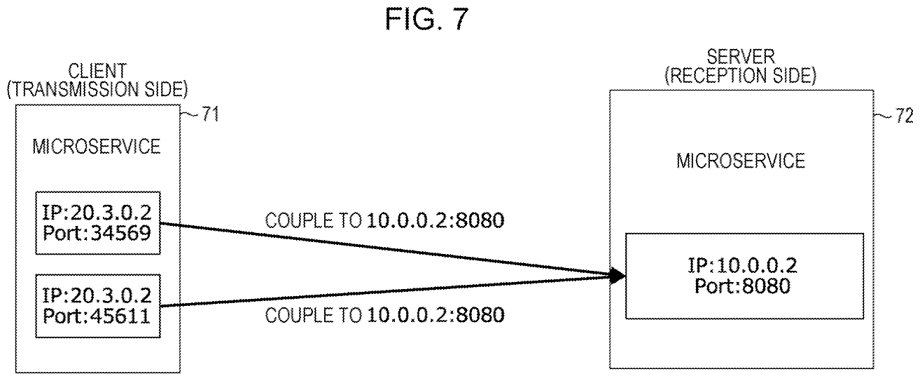

FIG. 7 is a diagram for explaining communication between microservices 71 and 72 in the related example.

A transmission side functions as the microservice 71 of a client, and a reception side functions as the microservice 72 of a server. Between the microservices 71 and 72, an HTTP/gRPC message is transmitted.

As illustrated in FIG. 7, an Internet Protocol (IP) address in the microservice 71 on the transmission side and an IP address/port number in the microservice 72 on the reception side are fixed. On the other hand, a port number in the microservice 71 on the transmission side changes.

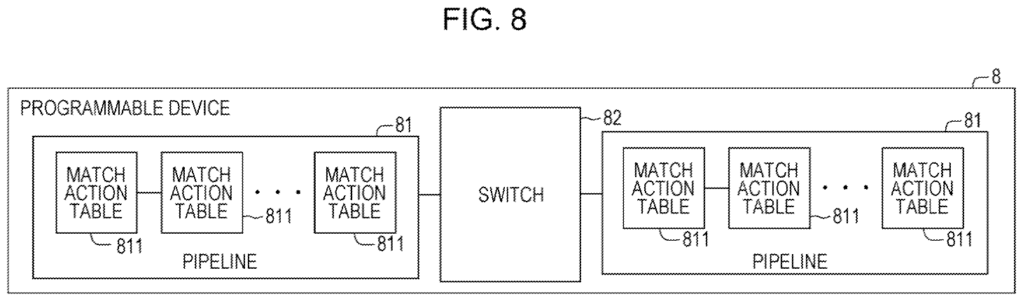

FIG. 8 is a diagram illustrating a configuration example of a programmable device 8 in the related example.

The programmable device 8 may freely operate a hardware device by software, and may dynamically change the function of the hardware device. The programmable device 8 may include a programmable switch or an NIC.

As illustrated in FIG. 8, the programmable device 8 includes two pipelines 81 and one switch 82.

The pipelines 81 are respectively provided at a preceding stage and a subsequent stage of the switch 82, and include a plurality of match action tables 811 (may be also referred to as “stages”). The pipeline 81 is able to treat internal information (for example, a queue length, an in/out port, and specific header information) of the switch 82 as metadata in the match action table 811. The pipeline 81 is able to perform processing such as counting a specific packet by using the match action table 811.

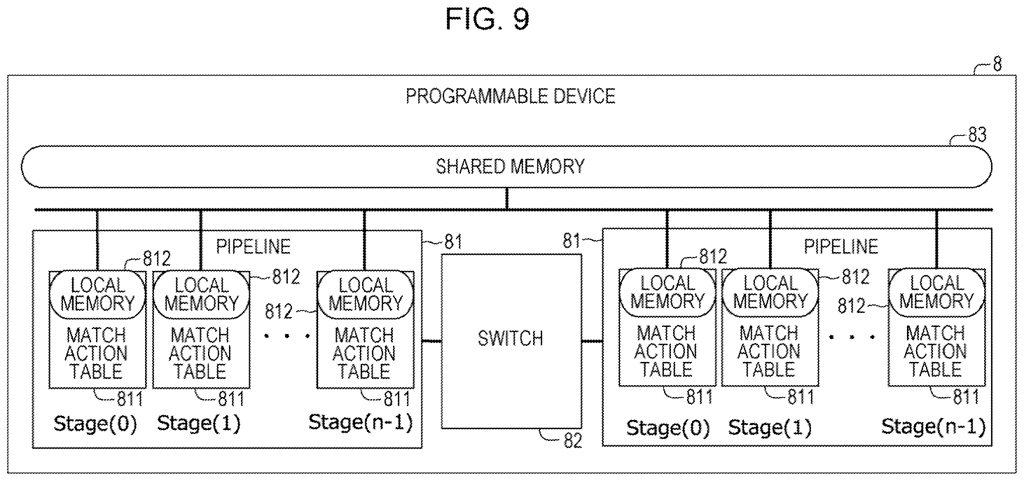

FIG. 9 is a diagram illustrating a memory architecture of the programmable device 8 in the related example.

In the programmable device 8, a local memory 812 exists in each match action table 811. A shared memory 83 (may be also referred to as “global memory”) is coupled to each local memory 812.

The local memory 812 is configured as a multistage table (may be also referred to as “multistage”) in each match action table 811. The local memory 812 is a ternary content addressable memory (TCAM), a static random-access memory (SRAM), or the like, and operates at high speed although it has a small capacity (for example, several to several tens of megabytes).

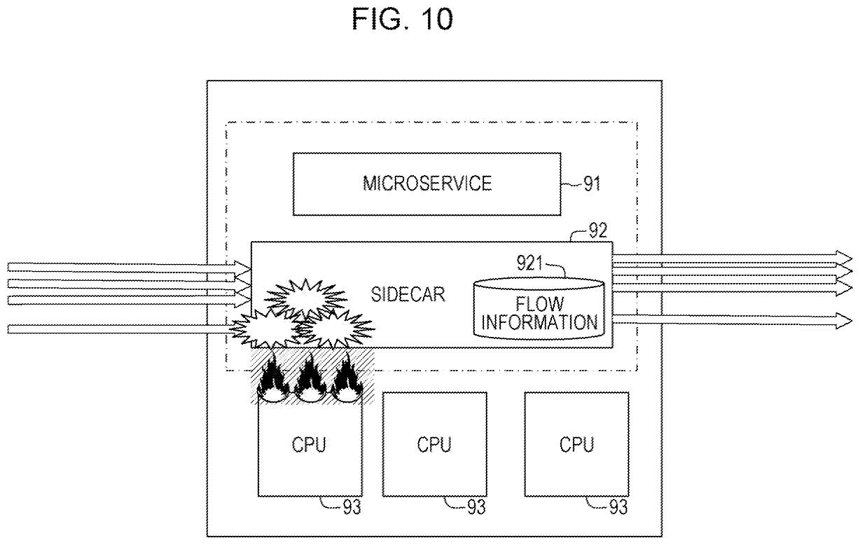

The shared memory 83 exists outside the match action table 811. The shared memory 83 is a dynamic random-access memory (DRAM) or the like and operates at a low speed although it has a large capacity (for example, several to several tens of gigabytes). In order to refer to the shared memory 83 from the match action table 811, latency occurs due to passing through a CPU (described later with reference to FIG. 10).

A service configured by a plurality of microservices may be configured, for example, on the assumption indicated in the following (1) to (6).

(1) A flow (for example, HTTP traffic) from a user uses the cookie or token to maintain stateful.

(2) Communication between the microservices is operated on the Transmission Control Protocol (TCP), and HTTP or gRPC is mainly used.

(3) Depending on the scale of the service, there may be provided a gateway or an ingress load balancer.

(4) The metadata is able to be embedded in a header of a TCP/IP packet. The metadata may be embedded by using an option field. The metadata may be embedded in a header of TCP/HTTP or the like.

(5) In each microservice, there exists a sidecar (Proxy). Statistics are able to be collected according to the parsing of the HTTP header or the HTTP level.

(6) On the server side, there exists the programmable device 8 (for example, NIC).

In the microservice, it is desired to track a flow (for example, connection) to generate a span and monitor the microservice by using a hardware function, without using an additional code such as an annotation.

For that purpose, the span is generated in the same format as the existing annotation base, thereby compatibility is maintained. For example, a trace ID, a parent ID, a span ID, and the like are managed using the hardware function, and the trace data is stored in the collector.

A time stamp is generated in a nanosecond level by using a hardware time stamp.

By these, the delay of the network which could not be observed only with the span is able to be observed.

FIG. 10 is a diagram for explaining a flow tracking in a container-based sidecar 92 in the related example.

As illustrated in FIG. 10, the flow tracking may be also generated with the container-based sidecar 92 corresponding to the microservice 91.

However, in order to track a plurality of flows, a lot of memory space is consumed. For maintaining the tracking tables of the flows, many CPUs 93 are used. When the container occupies all the CPUs 93, all the flow information 921 held by the container is lost when the container is restarted.

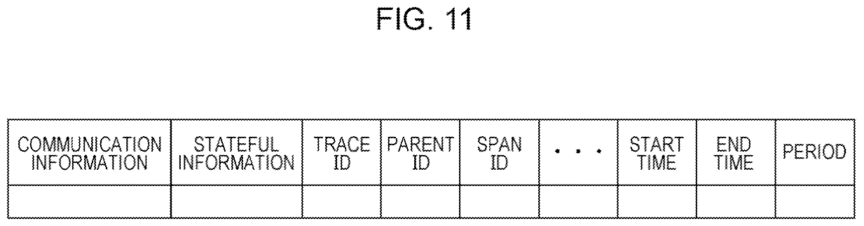

FIG. 11 is a diagram for exemplifying the communication tracing table in the related example.

The illustrated communication tracing table includes communication information (for example, a transmission/reception IP, a port, and a protocol) of the flow and information for tracing (for example, a span ID, a parent ID, a trace ID, time, and stateful information).

Such information is not able be stored in the local memory 812 of a small capacity of the programmable device 8. When storing in the shared memory, a memory copy is generated by the CPU 93 for the access, and extra latency is increased.

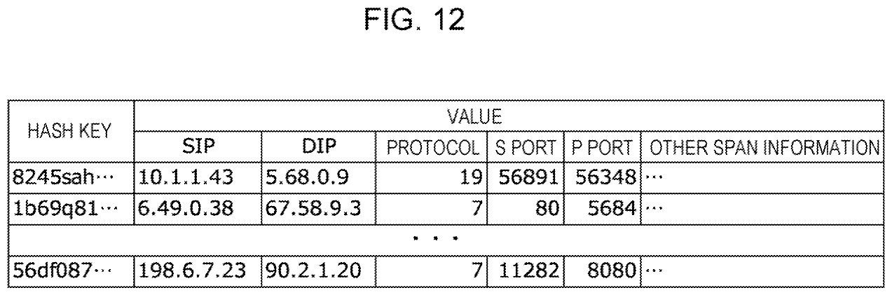

FIG. 12 is a table for explaining a resource saving method for the local memory 812 in the related example.

In order to save resources in the local memory 812, it is assumed that a hash key is generated by hashing communication information of each flow, and access to communication information or span information of each flow is performed based on the hash key is assumed.

In the example illustrated in FIG. 12, the hash key is associated with the value of each flow (for example, SIP, DIP, protocol, and the like).

The table illustrated in FIG. 12 may be accommodated in the local memory 812 when the number of entries is small, but it becomes difficult to accommodate the table when the number of entries is large.

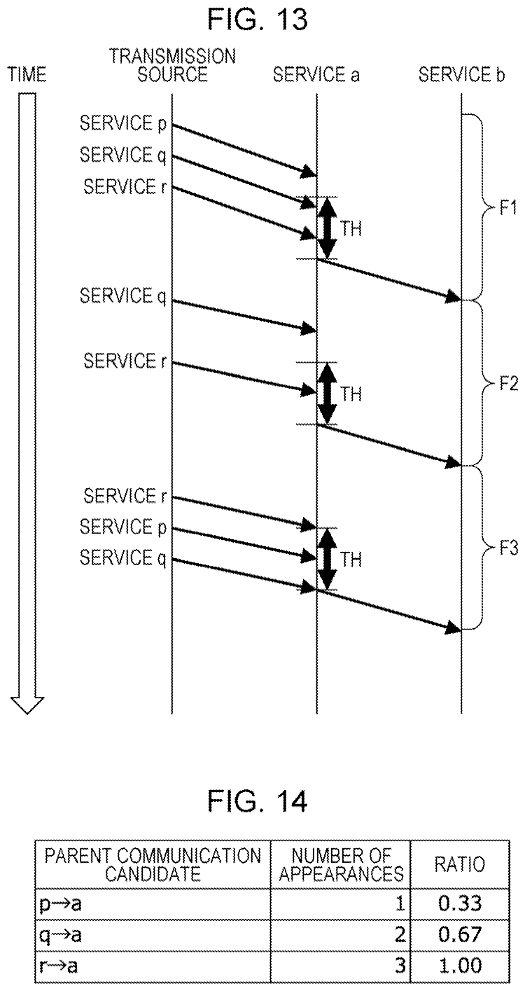

FIG. 13 is a sequence diagram for explaining a method for estimating the Span ID in the related example. FIG. 14 is a table for explaining a method for estimating the Span ID in the related example.

On the host side, a packet capture is performed at a plurality of points, and a parent span ID is estimated according to an appearance frequency of a transmission source candidate based on a capture result and a timing (TH) when a request arrives.

In the example illustrated in FIG. 13, as indicated by reference signs F1 to F3, the communication from the service a to the service b is performed three times.

As indicated by reference sign F1, in the time TH, the communication received in the service a is, the service q→a and the service r→a. As indicated by reference sign F2, in the time TH, the communication received in the service a is, the service r→a. As indicated by reference sign F3, in the time TH, the communication received in the service a is, the service r→a, the service p→a, and the service q→a.

When the communications in the times TH respectively indicated by the reference signs F1 to F3 are totaled, as illustrated in FIG. 14, the service r a as the parent communication candidate becomes 1.00 in the ratio and 3 times in the number of appearances, which are the maximum. By this, communication with the highest ratio may be estimated as the parent communication.

However, it is not easy to determine an appropriate time TH (may be also referred to as a “threshold”).

It is required to recognize in advance which microservice (in other words, “container”) is associated with which virtual port. There is a case where hundreds of containers are deployed in one server, and it is not easy to find a target virtual port. When the container is restarted, the IP address and the virtual port of the capture target are changed, so new information is collected again.

Although the CPU 93 for tracking the flow is not required, a processing load is generated due to capturing at a plurality of points on the host side. The processing load increases as the number of simultaneously generated flows increases.

### EXAMPLE OF EMBODIMENT

System Configuration Example

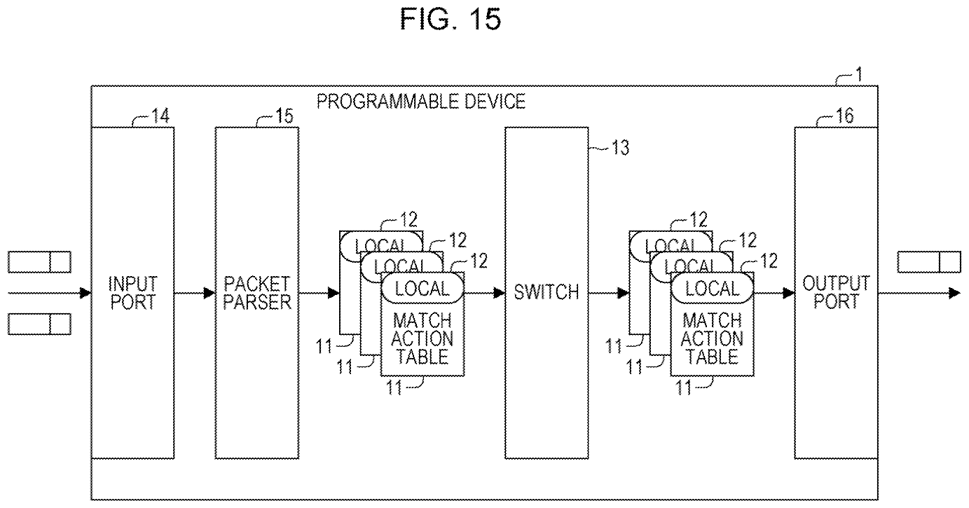

FIG. 15 is a block diagram illustrating the configuration example of the programmable device 1 according to an example of an embodiment.

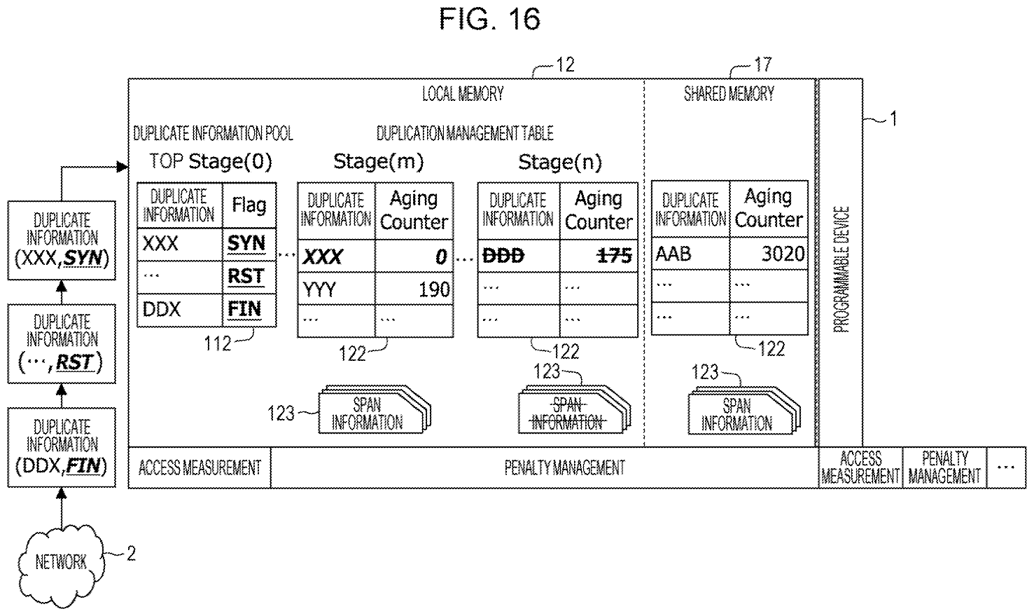

The programmable device 1 is an example of a computer and includes multistage match action tables 11, a switch 13, an input port 14, a packet parser 15, and an output port 16. The multistage match action tables 11 are provided at the preceding stage and the subsequent stage of the switch 13. The programmable device 1 includes a shared memory 17 as described later with reference to FIG. 16.

The input port 14 receives an input of a packet from the outside.

The packet parser 15 extracts information of a plug or a source port.

A plurality of match action tables 11 are respectively provided at the preceding stage and the subsequent stage of the switch 13, and perform processing in a distributed manner. Each match action table 11 is provided with a local memory 12.

The switch 13 performs various processing on the packet.

The output port 16 outputs a packet from the programmable device 1.

FIG. 16 is a diagram for explaining an outline of memory latency reduction processing in the example of the embodiment.

In the programmable device 1, a packet from the network 2 having the same transmission IP, the reception IP, and the port of the microservice is treated as duplicate information. As illustrated in FIG. 16, the memory latency is reduced by dividing the multistage match action tables 11 (may be also referred to as “stages”) into a duplicate information pool 112 and a duplication management table 122, and controlling the duplicate information pool 112 and the duplication management table 122 in two time slots. The two time slots are for an access measurement and a penalty management.

In the duplicate information pool 112 in Stage (0) at the top, a key is generated from duplicate information of the received TCP packet, and a flag (for example, SYN/FIN/RST) is stored. The flag will be described later with reference to FIG. 20 or the like. For example, in the access measurement, new duplicate information is stored in the duplicate information pool 112 and is waited for a predetermined time for giving a penalty.

In the duplication management table 122 in Stage (1) and the stage subsequent to Stage (1), duplicate information (in other words, “key”) and an aging counter value (in other words, “penalty”) are stored. For example, in the penalty management, the entry and the span information of each duplication management table 122 are inserted or deleted for new duplicate information based on a TCP flag (SYN/FIN/RST). A penalty is given to an entry having no access, and an entry having an aging counter greater than or equal to a threshold is moved to the subsequent stage.

When the access measurement and the penalty management are completed, the access measurement and penalty management are repeatedly performed thereafter.

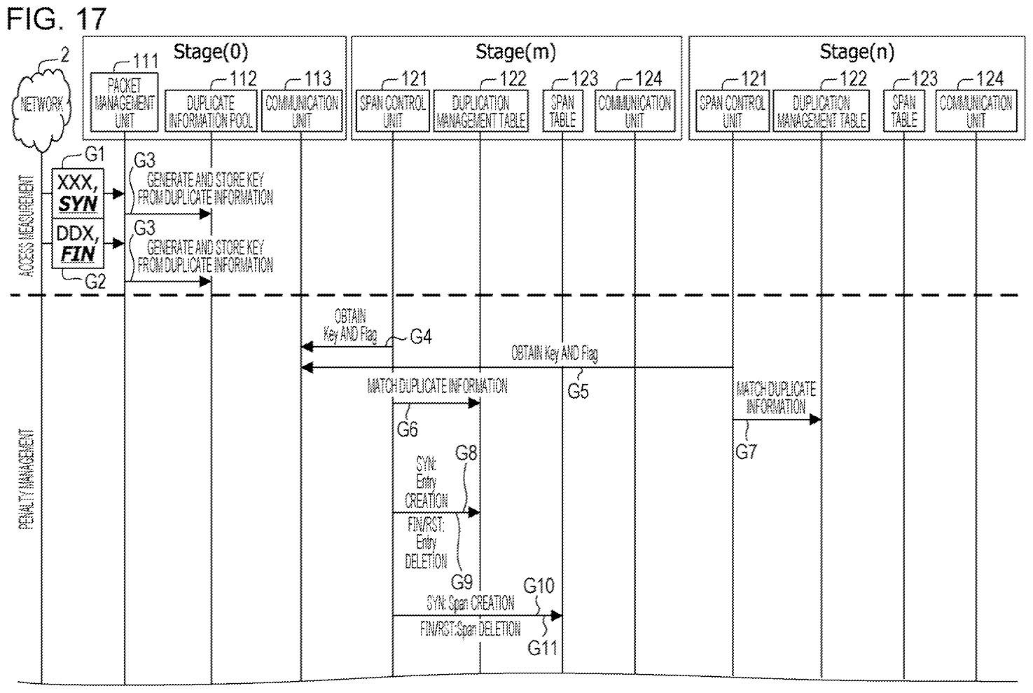

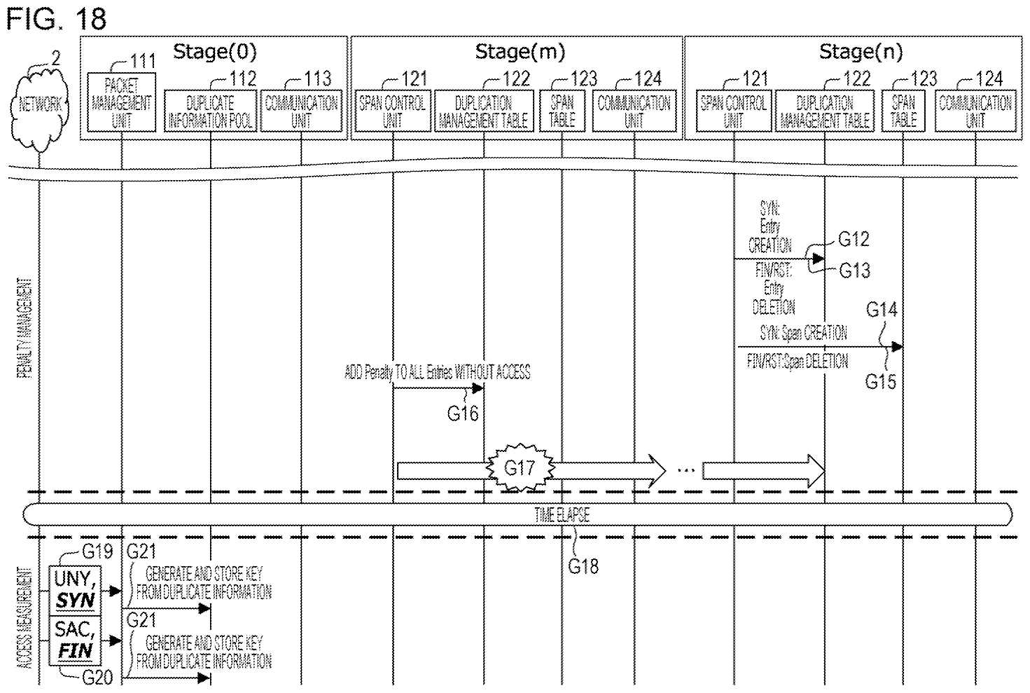

FIGS. 17 and 18 are sequence diagrams for explaining the outline of memory latency reduction processing illustrated in FIG. 16.

Stage (0) includes a packet management unit 111, the duplicate information pool 112, and a communication unit 113.

Stage (1) and the stage subsequent to Stage (1) include a span control unit 121, a duplication management table 122, a span table 123, and a communication unit 124.

As illustrated in FIG. 17, in the time slot of the access measurement, the packet management unit 111 of Stage (0) receives packets of (Key, Flag)=(XXX, SYN) and (DDX, FIN) from the network 2. (refer to reference signs G1 and G2). SYN indicates an entry insertion into the stage, and FIN indicates an entry deletion from the stage.

The packet management unit 111 of Stage (0) generates a key from duplicate information and stores the key in the duplicate information pool 112 (refer to reference sign G3).

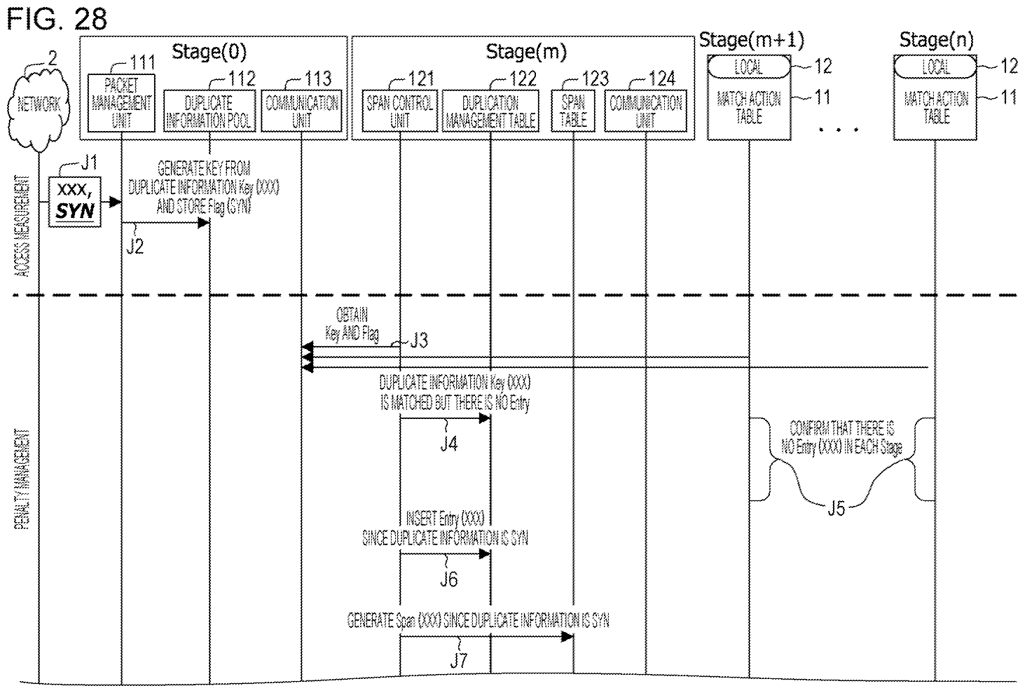

In the penalty management time slot, the span control unit 121 of each stage such as Stage (m) and Stage (n) obtains a key and flag through the communication unit 113 of Stage (0) (refer to reference signs G4 and G5 in FIG. 28).

The span control units 121 of Stage (m) and Stage (n) match the duplicate information from the duplicate information pool 112 in the duplication management tables 122 (refer to reference signs G6 and G7).

The span control unit 121 of Stage (m) creates an entry of SYN in the duplication management table 122 (refer to reference sign G8) and deletes an entry of FIN (refer to reference sign G9).

The span control unit 121 of Stage (m) creates a span of SYN in the span table 123 (refer to reference sign G10) and deletes a span of FIN (refer to reference sign G11).

As illustrated in FIG. 18, the span control unit 121 of Stage (n) creates the entry of SYN in the duplication management table 122 (refer to reference sign G12) and deletes the entry of FIN (refer to reference sign G13).

The span control unit 121 of Stage (n) creates the span of SYN in the span table 123 (refer to reference sign G14) and deletes the span of FIN (refer to reference sign G15).

The span control unit 121 of Stage (m) adds a penalty to all entries having no access (refer to reference sign G16).

When the penalty value is greater than or equal to the threshold, the span control unit 121 of Stage (m) moves the duplicate information to another stage through the communication unit 113 (refer to reference sign G17).

When a predetermined time elapses (refer to reference sign G18), the access measurement time slot is started again.

The packet management unit 111 of Stage (0) receives packets of (Key, Flag)=(UNY, SYN) and (SAC, FIN) from the network 2 (refer to reference signs G19 and G20).

The packet management unit 111 of Stage (0) generates the key from the duplicate information and stores the key in the duplicate information pool 112 (refer to reference sign G21). Thereafter, the penalty management time slot is started again.

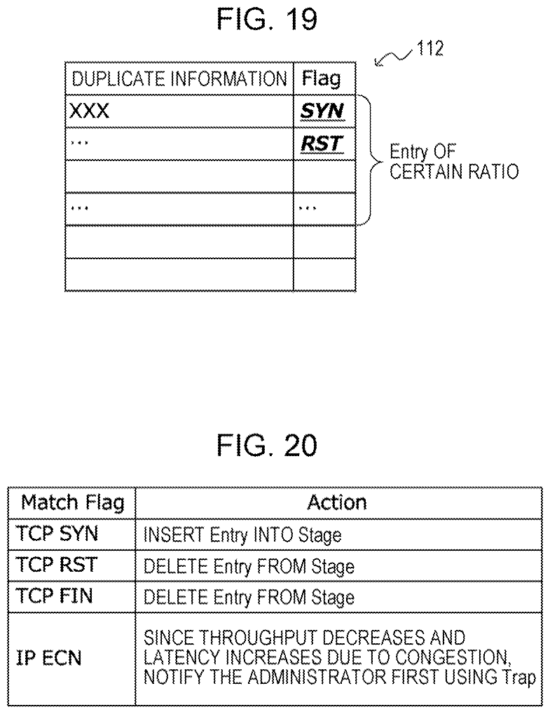

FIG. 19 is a table illustrating the duplicate information pool 112 in the example of the embodiment.

The time of the access measurement time slot may be adjusted as follows, for example.

When the number of entries of the duplicate information pool 112 reaches a certain ratio (for example, 80%) or more within the predetermined time, it may be switched to the penalty management time slot.

Even though the predetermined time is exceeded, if the number of entries of the duplicate information pool 112 is equal to or less than a certain ratio (for example, 10%), it may not be switched to the penalty management time slot.

For example, the switching timing of the time slot may be determined according to how many entries are embedded.

FIG. 20 is a table illustrating a definition of a match flag in the example of the embodiment.

The match flag is an example of a flag, and indicates processing for the received packet by being added to the duplicate information including the transmission source address and the transmission destination address. As illustrated in FIG. 20, TCP SYN indicates that the entry is inserted to the stage as an action, and TCP RST and TCP FIN indicate that the entry is deleted from the stage as an action.

Not only a TCP flag but also ECN of an IP header or the like may be used. IP ECN indicates that, because the throughput is reduced and latency is increased due to congestion, notification to the administrator is performed using trap as an action. The notification may be executed by the communication unit 113 of Stage (0).

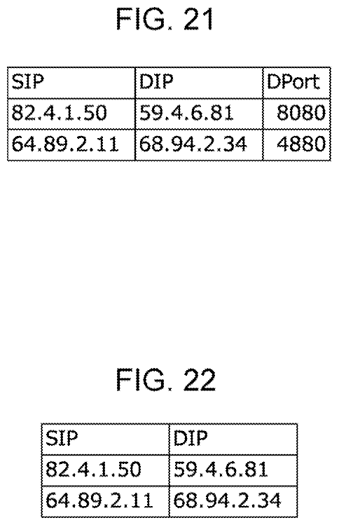

FIG. 21 is a table illustrating a first example of duplicate information in the example of the embodiment. FIG. 22 is a table illustrating a second example of duplicate information in the example of the embodiment.

As illustrated in FIG. 21, the duplicate information may include a common transmission side IP (SIP), a reception side IP (DIP), and a reception side port (DPort) in the microservice.

However, when the port number on the reception side of the microservice is fixed, the duplicate information may not include the reception side port (DPort) as illustrated in FIG. 22.

In addition, the duplicate information may include a transmission side port (SPort), or may include both the reception side port (DPort) and the transmission side port (SPort).

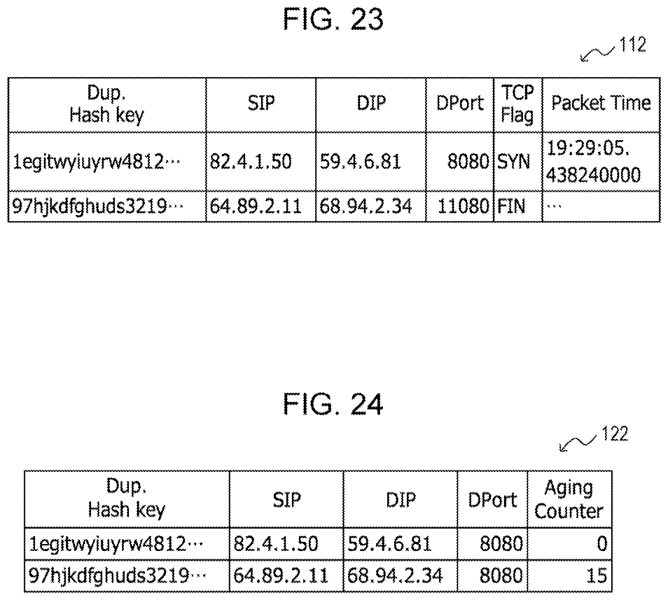

FIG. 23 is a table illustrating details of the duplicate information pool 112 in the example of the embodiment.

The duplicate information pool 112 is a table that stores duplicate information and TCP flag and generates a hash key. The duplicate information pool 112 may include Dup. Hash key, SIP, DIP, DPort, TCP flag, and packet time.

The Dup. Hash key is a hash key generated by duplicate information (for example, SIP, DIP, and DPort). SIP is an IP address on the transmission side. DIP is an IP address on the reception side. DPort is a port number on the reception side. Packet time is a time when the packet is received. The TCP flag is a flag in the TCP header and is used as one of means for managing the entry.

SYN indicates that a TCP flow (in other words, connection) is generated, and SPAN is generated.

FIN indicates that the TCP flow (in other words, connection) is terminated, and the entry is able to be immediately deleted in the penalty management time slot.

RST indicates that the TCP flow (in other words, connection) is terminated, and the entry is able to be deleted immediately in the penalty management time slot.

FIG. 24 is a diagram illustrating details of the duplication management table 122 in the example of the embodiment.

The duplication management table 122 is a table that stores duplicate information and generates a hash key. The duplicate information pool 112 may include Dup. Hash key, SIP, DIP, DPort, and Aging Counter.

The Dup. Hash key is a hash key generated by duplicate information (for example, SIP, DIP, and DPort). SIP is an IP address on the transmission side. DIP is an IP address on the reception side. DPort is a port number on the reception side. The aging counter is a value set according to the access frequency and the elapsed time, and is moved to the shared memory 17 when the value exceeds the threshold to become a higher value.

When there is no access to the duplicate information, a fixed value is added to the aging counter as a penalty, and the value is shifted to the shared memory 17 side as the value increases. When a hit occurs in the duplicate information, the aging counter is initialized to 0, and the entry is moved to the hash table of the top on the local memory 12 side.

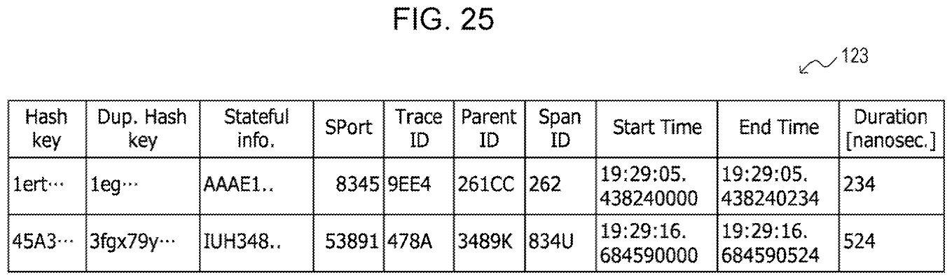

FIG. 25 is a diagram illustrating a span table 123 in the example of the embodiment.

In the span table 123, there exists span information, and entries are managed based on the duplicate information.

Hash key is a hash key generated by SPort, Dup. Hash key, and Stateful info. The Dup. Hash key is a hash key of the duplication management table 122. The stateful info, indicates a cookie or a token. Trace ID is an ID shared by the entire span. Parent ID indicates an ID of the parent span. Span ID indicates its own span ID. The start time indicates the time when SYN of TCP flow of HTTP arrives based on information of the duplicate information pool 112. End time indicates the time when FIN of TCP flow of HTTP arrives based on information of the duplicate information pool 112. Duration indicates time obtained by subtracting the Start Time from the End Time.

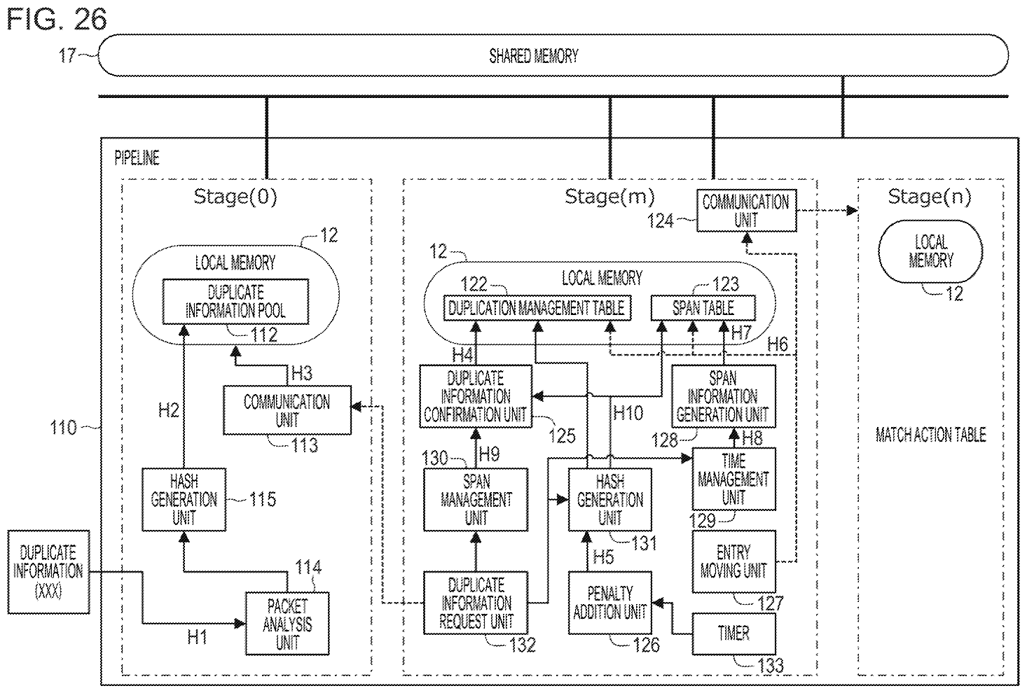

FIG. 26 is a block diagram illustrating a functional configuration example of the programmable device 1 according to the example of the embodiment.

As illustrated in FIG. 26, each stage is developed to a pipeline 110, and the shared memory 17 is coupled to the pipeline 110.

Stage (0) functions as the communication unit 113, the packet analysis unit 114, and the hash generation unit 115, and holds the duplicate information pool 112 in the local memory 12. The packet analysis unit 114 and the hash generation unit 115 correspond to the packet management unit 111 illustrated in FIGS. 17 and 18.

The packet analysis unit 114 extracts a TCP/IP header from the packet and detects TCP SYN/FIN (refer to reference sign H1). The packet analysis unit 114 transmits the packet information to the hash generation unit 115. The packet analysis unit 114 stores SYN/FIN/RST of TCP in the duplicate information pool 112.

The hash generation unit 115 generates Dup. Hash key of duplicate information (for example, SIP, DIP, and DPort) from the current packet and stores it in the duplicate informaton pool 112 (refer to reference sign H2).

The duplicate information pool 112 is an example of a first area that records a key generated from duplicate information including a transmission source address and a transmission destination address of a received packet, and a specific flag, when the flag of the received packet is a specific flag.

The communication unit 113 of Stage (0) obtains the key and flag from the duplicate information pool 112 based on a request from Stage (1) and the stage subsequent to Stage (1) (refer to reference sign H3).

The Stage (1) and the stage subsequent to Stage (1) function as a communication unit 124, a duplicate information confirmation unit 125, a penalty addition unit 126, an entry moving unit 127, a span generation unit 128, a time management unit 129, a span management unit 130, a hash generation unit 131, a duplicate information request unit 132, and a timer 133. In the local memory 12 in Stage (1) and the stage subsequent to Stage (1), the duplication management table 122 and the span table 123 are held. The duplicate information confirmation unit 125, the penalty addition unit 126, the entry moving unit 127, the span generation unit 128, the time management unit 129, the span management unit 130, the hash generation unit 131, and the duplicate information request unit 132 correspond the span control unit 121 illustrated in FIGS. 17 and 18.

The duplicate information confirmation unit 125 confirms whether the Dup. Hash Key in the duplication management table 122 matches the hash key of the current packet (refer to reference sign H4).

The penalty addition unit 126 adds the value of the aging counter to all the entries of the duplication management table 122 by referring to the timer 133 (refer to reference sign H5).

The penalty addition unit 126 is an example of an update unit that updates a counter indicating an access frequency to duplicate information included in the duplication management table 122 (in other words, “second area”) in the local memory 12 for each processing, according to the received packet.

The entry moving unit 127 moves the entry in which the aging counter is greater than or equal to a threshold or more to another stage or the shared memory 17 via the communication unit 113 (refer to reference sign H6).

The entry moving unit 127 refers to the duplication management table 122 (in other words, “second area”) for each processing in the access measurement time slot (in other words, “second timing”). The entry moving unit 127 is an example of a moving unit of moving the entry in the duplication management table 122 in which the aging counter is greater than or equal to a threshold from the local memory 12 to the local memory 12 or the shared memory 17 in the next stage (in other words, “subsequent stage”).

The span generation unit 128 generates a trace ID, a parent ID, and a span ID based on stateful information, and records a timestamp from the time management unit 129 in the span table 123 (refer to reference sign H7).

The time management unit 119 generates a timestamp at the timing of receiving a notification that SYN/FIN of TCP is completed, and sends it to the span generation unit 118 (refer to reference sign H8).

The span management unit 130 inserts or extracts span information existing between the TCP/IP header and the payload (refer to reference sign H9).

The hash generation unit 1.31 generates a Dup. Hash key of duplicate information (for example, SIP, DIP, and DPort) from the current packet. The hash generation unit 131 generates a hash key from SPort, Dup. Hash Key, and Stateful info. of the current flow, and stores the hash key in the span table 123 (refer to reference sign H10).

The hash generation unit 131 is an example of a processing unit that executes processing corresponding to each flag in the duplicate information pool 112 (in other words, “first area”) accumulated in the first timing, in the duplication management table 122 (in other words, “second area”).

### EXAMPLE OF OPERATION

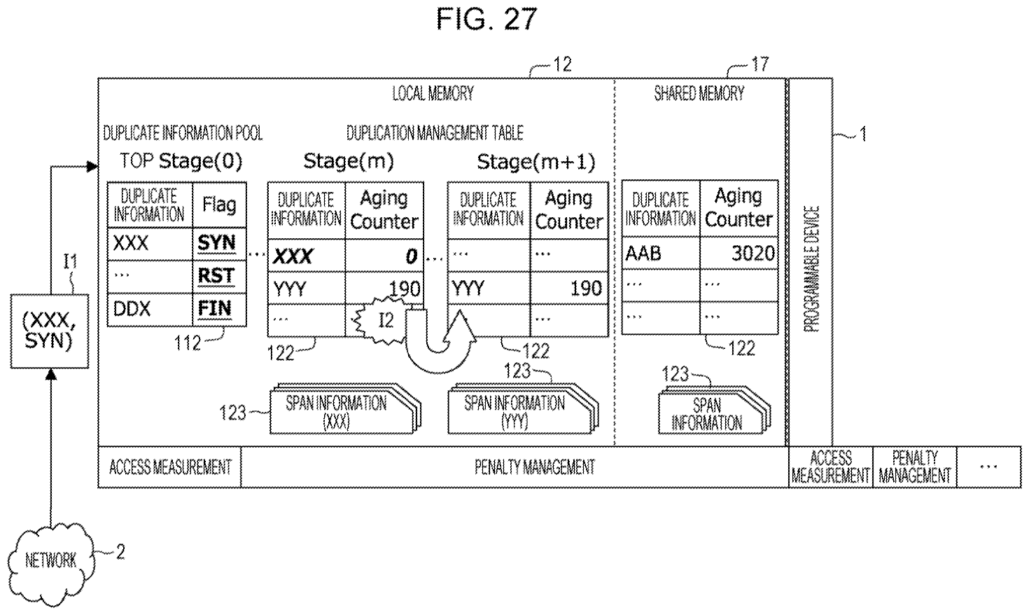

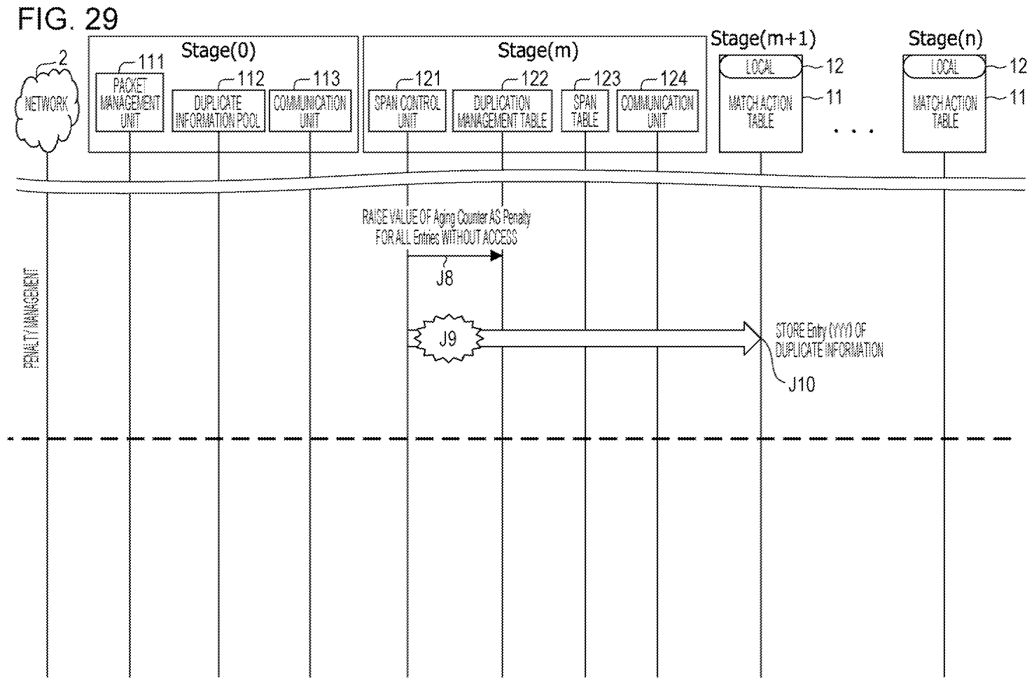

Hereinafter, with reference to FIG. 27, entry insertion processing in the programmable device 1 in the example of the embodiment will be described by using sequence diagrams (refer to reference signs 31 to 310) illustrated in FIGS. 28 and 29.

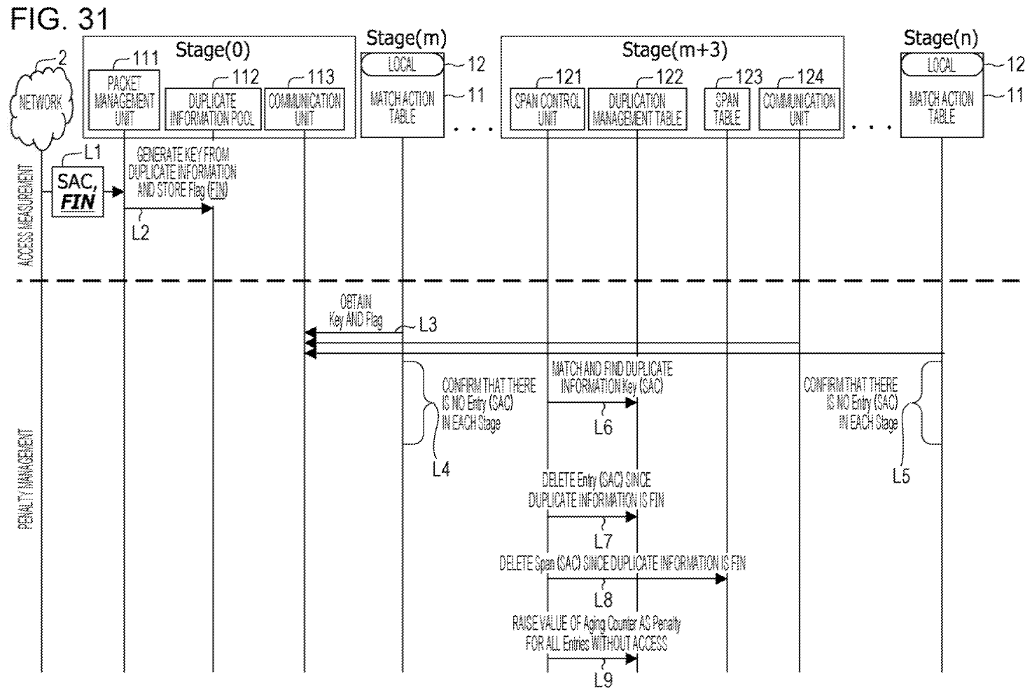

As illustrated in FIGS. 27 and 28, the packet management unit 111. of Stage (0) receives a packet of SYN of the new connection from the network 2 in the access measurement time slot (refer to reference signs 11 in FIGS. 27 and 31 in FIG. 28).

The packet management unit 111 of Stage (0) generates a key from the duplicate information and stores the key in the duplicate information pool 112 (refer to reference sign 32 in FIG. 28).

In the penalty management time slot, the span control unit 121 of each stage such as Stage (m), Stage (m+1), and Stage (n) obtains the key and flag through the communication unit 113 of Stage (0) (refer to reference sign 33 in FIG. 28).

The span control unit 121 of Stage (m) confirms that the duplicate information Key (XXX) is matched in the duplication management table 122 but is not in the entry (refer to reference sign 34 in FIG. 28).

In each stage such as Stage (m+1) and Stage (n), it is confirmed that there is no Key (XXX) as an entry (refer to reference sign 35 in FIG. 28).

The span control unit 121 of Stage (m) inserts Entry (XXX) into the duplication management table 122 because duplicate information is SYN (refer to reference sign 36 in FIG. 28).

The span control unit 121 of Stage (m) generates Span (XXX) in the span table 123 because the duplicate information is SYN (refer to reference sign 37 in FIG. 28).

In FIG. 29, the span control unit 121 of Stage (m) increases the value of the aging counter as a penalty for all entries having no access in the duplication management table 122 (refer to reference sign 38 in FIG. 29).

The span control unit 121 of Stage (m) moves to the next Stage (m+1) because the value of Entry (YYY) of the duplication management table 122 is 190 and is greater than or equal to a threshold (for example, 180) (refer to reference sign 12 in FIGS. 27, and 39 in FIG. 29).

In Stage (m+1), Entry (YYY) of duplicate information is stored (refer to reference sign 310 in FIG. 29). The entry insertion processing ends.

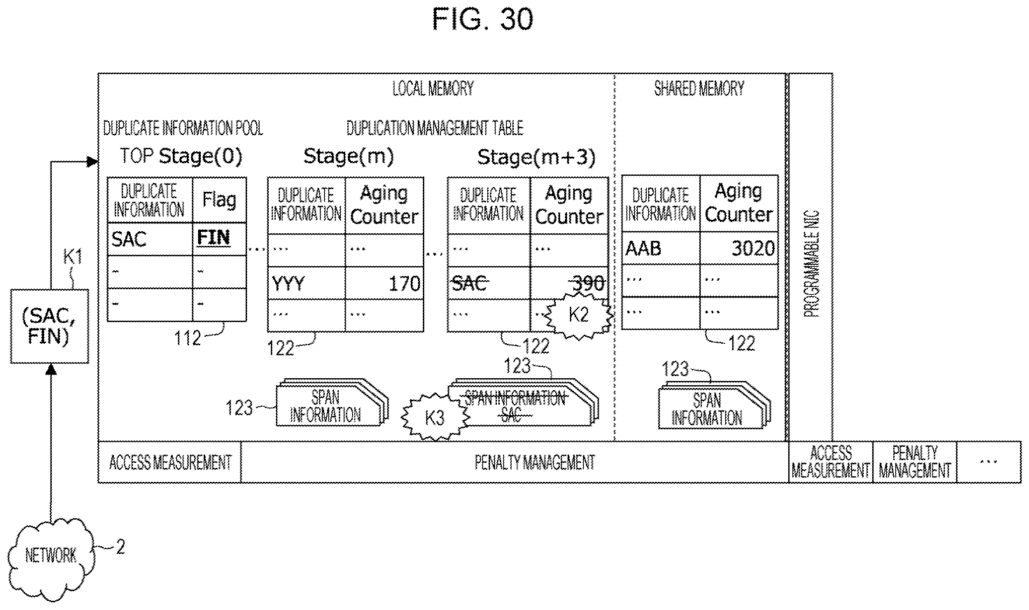

Next, with reference to FIG. 30, entry deletion processing in the programmable device 1 in the example of the embodiment will be described by using the sequence diagram (refer to reference signs L1 to L9) illustrated in FIG. 31.

As illustrated in FIGS, 30 and 31, the packet management unit 111 of Stage (0) receives a packet of FIN of connection from the network 2 in the access measurement time slot (refer to reference signs K1 in FIG. 30 and L1 in FIG. 31).

The packet management unit 111 of Stage (0) generates Key (SAC) from duplicate information and stores it in the duplicate information pool 112 (refer to reference sign L2 in FIG. 31).

In the penalty management time slot, the span control unit 121 of each stage such as Stage (m), Stage (m+3), and Stage (n) obtains the key and flag through the communication unit 113 of Stage (0) (refer to reference sign L3 in FIG. 31).

In each stage such as Stage (m) and Stage (n), it is confirmed that there is no Key (SAC) as an entry (refer to reference signs L4 and L5 in FIG. 31).

The span control unit 121 of Stage (m+3) matches duplicate information Key (XXX) in the duplication management table 122 and finds it in the entry (refer to reference sign L6 in FIG. 31).

The span control unit 121 of Stage (m+3) deletes Entry (SAC) from the duplication management table 122 because the duplicate information is FIN (refer to reference signs K2 in FIG. 30 and L7 in FIG. 31).

The span control unit 121 of Stage (m) deletes Span (SAC) from the span table 123 because the duplicate information is SYN (refer to reference signs K3 in FIG. 30 and L8 in FIG. 31).

The span control unit 121 of Stage (m) increases the value of the aging counter as a penalty for all entries having no access in the duplication management table 122 (refer to reference sign L9 in FIG. 31) The entry deletion processing ends.

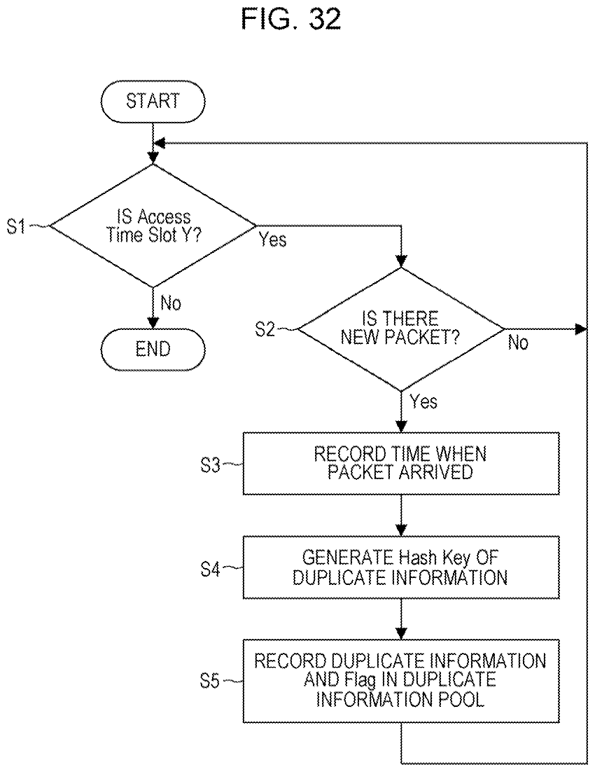

Next, processing in the access measurement time slot in the programmable device 1 according to the example of the embodiment will be described with reference to a flowchart (Steps S1 to S5) illustrated in FIG. 32.

The packet management unit 111 of Stage (0) determines whether the current time slot is an access measurement (“Access Time Slot” in the illustrated example) (Step S1).

When the current time slot is not the access measurement (refer to No route in Step S1), the processing in the access measurement time slot ends.

On the other hand, when the current time slot is the access measurement (refer to Yes route in Step S1), the packet management unit 111 determines whether there is a new packet received (Step S2).

If there is no new packet (refer to No route in Step S2), the processing returns to Step S1.

On the other hand, when there is a new packet (refer to Yes route in Step S2), the packet management unit 111 records the time when the packet arrives in the duplicate information pool 112 (Step S3).

The packet management unit 111 generates a hash key of duplicate information (Step S4).

The packet management unit 111 records the duplicate information and a flag in the duplicate information pool 112 (Step S5), and the processing returns to Step S1.

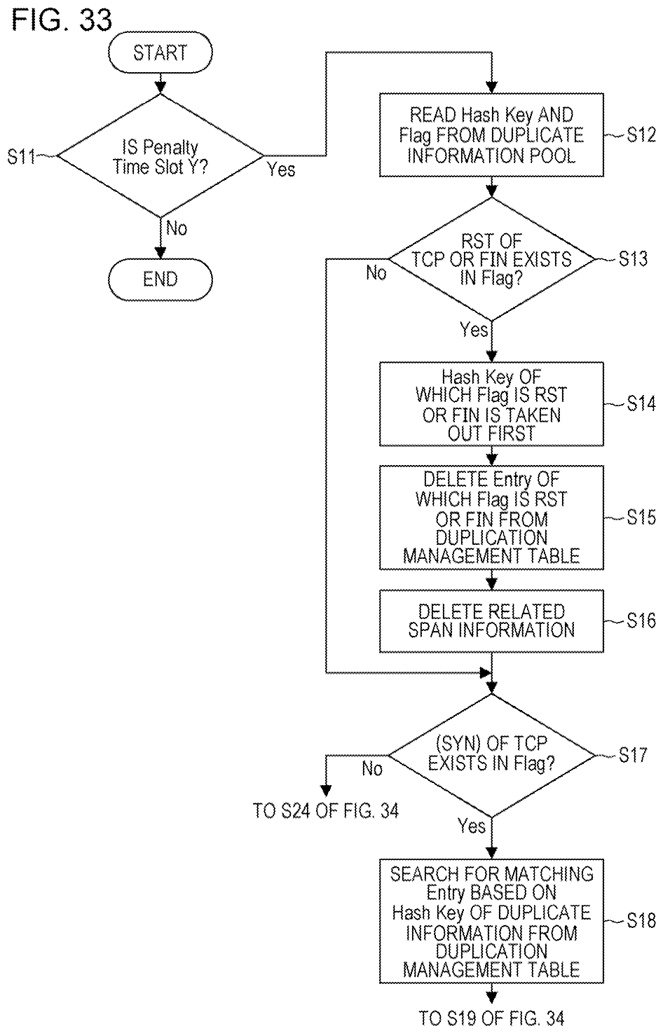

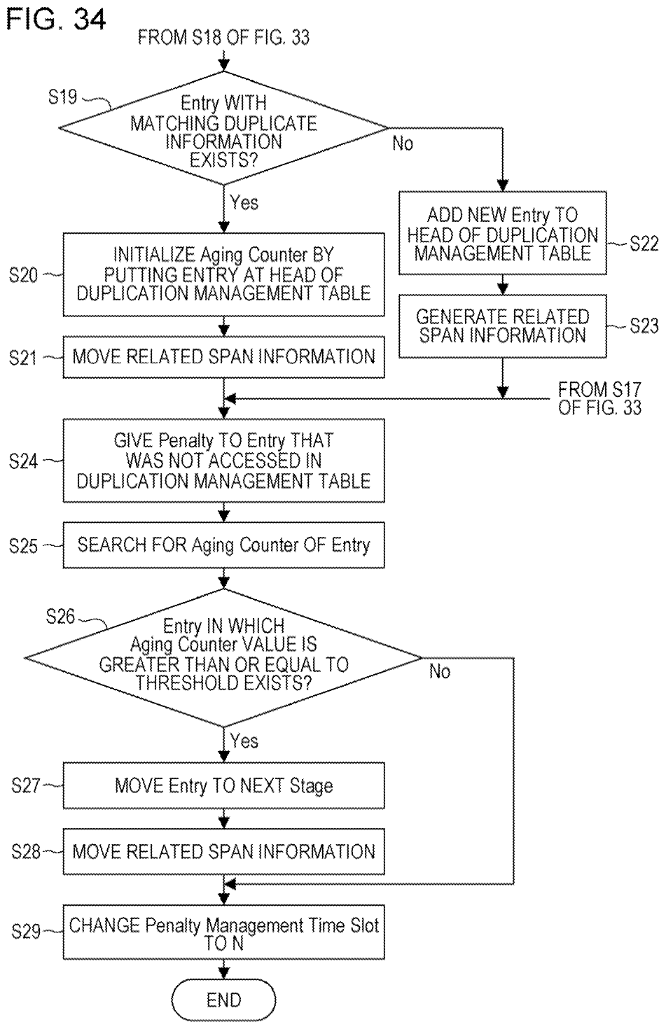

Next, processing in the penalty management time slot in the programmable device 1 in the example of the embodiment will be described with reference to flowcharts (Steps S11 to S29) illustrated in FIGS. 33 and 34.

The packet management unit 111 of Stage (0) determines whether the current time slot is penalty management (“Penalty Time Slot” in the illustrated example) (Step S11).

If the current time slot is not penalty management (refer to No route in Step S11), the processing in the penalty management time slot ends.

On the other hand, when the current time slot is penalty management (refer to Yes route in Step S11), the packet management unit 111 reads the hash key and the flag from the duplicate information pool 112 (Step S12).

The packet management unit 111 determines whether there is RST or FIN of TCP in the flag (Step S13).

When there is no RST or FIN of TCP in the flag (refer to No route in Step S13), the processing proceeds to Step S17.

On the other hand, when RST or FIN of TCP exists in the flag (refer to Yes route in Step S13), the packet management unit 111 extracts the hash key of which flag is RST or FIN first (Step S14).

The span control unit 121 of Stage (1) and the stage subsequent to Stage (1) deletes the entry of which the flag is RST or FIN from the duplication management table 122 (Step S15).

The span control unit 121 deletes related span information (Step S16).

The span control unit 121 determines whether there is SYN of TCP in the flag (Step S17).

When there is no SYN of TCP in the flag (refer to No route in Step S17), the processing proceeds to Step S24 in FIG. 34.

On the other hand, when SYN of TCP exists in the flag (refer to Yes route in Step S17), the span control unit 121 searches for a matching Entry from the duplication management table 122 based on the hash key of the duplicate information (Step S18).

In FIG. 34, the span control unit 121 determines whether there is an entry that duplicate information matches in the duplication management table 122 (Step S19).

When there is an entry that duplicate information matches (refer to Yes route in Step S19), the entry is put at the head of the duplication management table 122 to initialize the aging counter (Step S20).

The span control unit 121 moves the related span information (Step S21), and the processing proceeds to Step S24.

In Step S19, when there is no entry that duplicate information matches (refer to No route in Step S19), the span control unit 121 adds a new entry to the head of the duplication management table 122 (Step S22).

The span control unit 12 generates related span information (Step S23).

The span control unit 121 gives a penalty to the entry having no access in the duplication management table 122 (Step S24).

The span control unit 121 searches for the aging counter of the entry in the duplication management table 122 (Step S25).

The span control unit 121 determines whether there is an entry of which an aging counter value is greater than or equal to the threshold (Step S26).

When there is no entry in which the aging counter value is greater than or equal to the threshold (refer to No route in Step S26), the processing proceeds to Step S29.

When there is an entry in which the aging counter value is greater than or equal to the threshold (refer to Yes route in Step S26), the span control unit 121 moves the entry to the next stage (Step S27).

The span control unit 121 moves the related span information to the next stage (Step S28).

The span control unit 121 sets the flag of the penalty management time slot to “N” (Step S29), and the processing in the penalty management time slot ends.

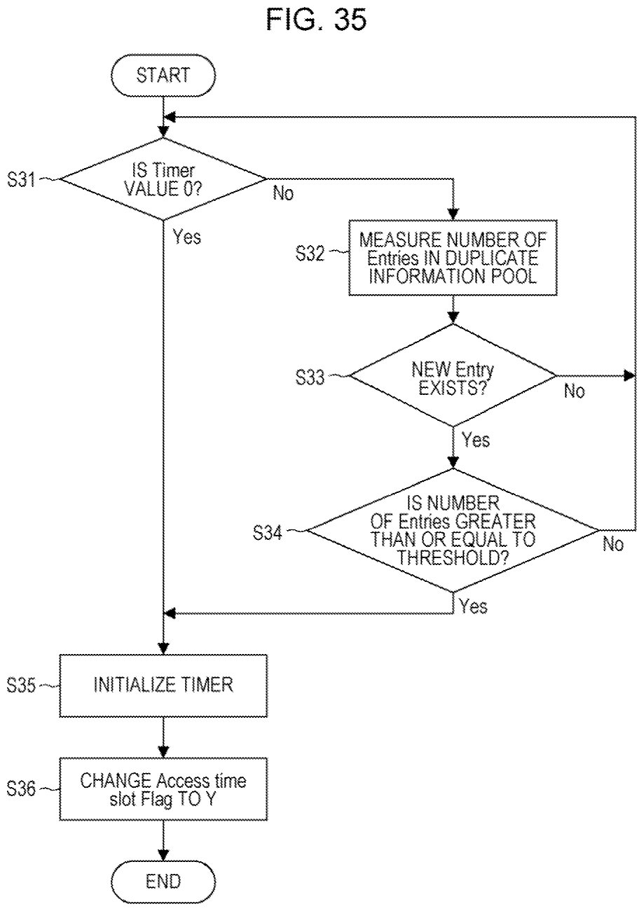

Next, time slot management processing in the programmable device 1 in the example of the embodiment will be described with reference to the flowchart illustrated in FIG. 35 (Steps S31 to S36).

The packet management unit 111 of Stage (0) determines whether a value of the timer 133 is “0” (Step S31).

When the value of the timer 133 is “0” (refer to Yes route in Step S31), the processing proceeds to Step 535.

On the other hand, when the value of the timer 133 is not “0” (refer to No route in Step S31), the packet management unit 111 measures the number of entries of the duplicate information pool 112 (Step S32).

The packet management unit 111 determines whether there is an entry newly registered in the duplicate information pool 112 (Step S33).

When there is no new entry (refer to No route in Step S33), the processing is returned to Step S31.

When there exists a new entry (refer to Yes route in Step S33), a packet management unit 111 determines whether the number of entries in the duplicate information pool 112 is greater than or equal to the threshold (Step S34).

When the number of entries is not greater than or equal to the threshold (refer to No route in Step S34), the processing is returned to Step S31.

On the other hand, when the number of entries is greater than or equal to the threshold (refer to Yes route in Step S34), the packet management unit 111 initializes the timer 133 (Step S35).

The packet management unit 111 changes an access time slot flag indicating that it is an access measurement time slot to “Y” (Step S36). The time slot management processing ends.

Effect

According to the monitoring program in the example of the embodiment described above, for example, the following action effects may be achieved.

When the flag of the received packet is a specific flag, the duplicate information pool 112 stores a key generated from the duplicate information including the transmission source address and the transmission destination address of the received packet and the specific flag. The penalty addition unit 126 updates the counter indicating the access frequency to duplicate information included in the duplication management table 122 (in other words, “second area”) in the local memory 12 for each processing, according to the received packet. The hash generation unit 131 executes processing corresponding to each flag in the duplicate information pool 112 (in other words, “first area”) accumulated in the first timing in the duplication management table 122 (in other words, “second area”). The entry moving unit 127 refers to the duplication management table 122 (in other words, “second area”) for each processing in the access measurement time slot (in other words, “second timing”). The entry moving unit 127 moves the entry in the duplication management table 122 in which the aging counter is greater than or equal to the threshold from the local memory 12 to the local memory 12 or the shared memory 17 of the next stage.

By this, the microservice may be monitored by the small-capacity local memory 12. For example, by using the duplicate information of the microservice as a key, the local memory 12 and the shared memory 17 are efficiently controlled based on the access frequency and the elapsed time, and an excessive load (in other words, “increase in latency”) by copying is able to be reduced.

For example, it is assumed that the number of entries that is able to be stored in the local memory 12 is 50,000 and that the number of entries that is able to be stored in the shared memory 17 is one million, and that latency by access (in other words, “copy”) between memories is 50 nanoseconds.

Three entries are stored in local memory 12 and seven entries are stored in the shared memory 17. Latency when the entry is accessed ten times within a predetermined time is assumed.

For sequential access to each memory, 7*50=350 ns is required as an extra load for accessing seven entries in the shared memory 17. When the load is repeated ten times, 350*10=3500 ns is required.

On the other hand, in the example of the above-described embodiment, the load may be reduced to one-tenth since the entry is disposed in the local memory 12 from the second access, although 350 ns is similarly required in the initial access.

When the number of entries in the duplicate information pool 112 becomes a predetermined number or more, the processing of access measurement is completed and processing in the penalty management is started. When the number of entries in the duplicate information pool 112 does not reach the predetermined number, the access measurement is continued.

By this, the access measurement time slot and the penalty management time slot may be efficiently switched.

The specific flag includes a flag defined by TCP and a flag defined by IP. When the specific flag is a flag defined by IP, it is notified that the throughput of the network 2 is reduced.

Thereby, the administrator may recognize the decrease in throughput at an early stage.

The duplicate information includes a transmission destination port number. The duplicate information includes a transmission source port number. The duplicate information may include both the transmission destination port number and the transmission source port number.

By this, even when one or both of the transmission destination port number and the transmission source port number are not fixed, the microservice may be monitored.

The flag added to duplicate information including the transmission source and the transmission destination address of the received packet and indicating processing to the received packet is a specific flag, the computer 1 stores a key generated from the duplicate information, and a specific flag in a first area 112 in a first local memory 12, updates a counter indicating an access frequency to the duplicate information included in a second area 122 in the first local memory 12 for each processing according to the received packet, performs processing corresponding to each flag in the first area accumulated in the first timing in the second area 122, and performs processing of moving the entry in the second area in which a counter is greater than or equal to a threshold from the first local memory 12 to the second local memory 17 at the subsequent stage of the first local memory by referring to the second area 122 for each processing in the second timing.

Others

The disclosed technique is not limited to the above-described embodiment, and various modifications may be made within a range not departing from the spirit of the embodiment. Each configuration and each processing of the embodiment may be selected as required, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium comprising a monitoring program which, when executed by a processor coupled to a first memory and a second memory, causes the processor to:
store, when a flag which is added to duplicate information including a transmission source address and a transmission destination address of a received packet and which indicates processing to the received packet is the specific flag, the flag in a first area in the first memory,
update a value of a counter indicating an access frequency to duplicate information included in a second area at the first memory for each processing according to the received packet,
execute processing in the second area corresponding to each flag in the first area accumulated at a first timing,
refer to the second area for each processing at a second timing, and
move an entry in the second area from the first memory to the second memory provided at a subsequent stage of the first memory when the updated value of the counter is equal to or greater than a threshold.

2. The non-transitory computer-readable recording medium of claim 1,
wherein the processor is to complete the processing relating to the first timing and start the processing at the second timing when the number of entries in the first area becomes greater than or equal to a predetermined number.

3. The non-transitory computer-readable recording mediumof claim 1,
wherein the processor is to continue the processing at the first timing when the number of entries in the first area is less than a predetermined number.

4. The non-transitory computer-readable recording medium of claim 1,
wherein the specific flag includes a flag defined by a communication protocol of a Transmission Control Protocol/Internet Protocol (TCP/IP) header.

5. The non-transitory computer-readable recording medium of claim 1,
wherein the duplicate information further includes a transmission destination port number.

6. The non-transitory computer-readable recording medium of claim 1,
wherein the duplicate information further includes a transmission source port number,

7. A programmable device comprising:
a first memory that stores, when a flag which is added to duplicate information including a transmission source address and a transmission destination address of a received packet and which indicates processing to the received packet is the specific flag, the flag in a first area in the first memory; and
a processor coupled to the first memory and the processor configured to:
update a value of a counter indicating an access frequency to duplicate information included in a second area at the first memory for each processing according to the received packet,
execute processing in the second area corresponding to each flag in the first area accumulated at a first timing,
refer to the second area for each processing at a second timing, and
move an entry in the second area from the first memory to a second memory provided at a subsequent stage of the first memory when the updated value of the counter is equal to or greater than a threshold.

8. The programmable device of claim 7,
wherein the processor completes the processing relating the first timing and starts the processing at the second timing when the number of entries in the first area becomes greater than or equal to a predetermined number.

9. The programmable device of claim 7,
wherein the processor continues the processing at the first timing when the number of entries in the first area is less than a predetermined number.

10. The programmable device of claim 7,
wherein the specific flag includes a flag defined by a communication protocol of a Transmission Control Protocol/Internet Protocol (TCP/IP) header.

11. The programmable device of claim 7,
wherein the duplicate information further includes a transmission destination port number.

12. The programmable device of claim 7,
wherein the duplicate information further includes a transmission source port number.

13. A computer-implemented monitoring method comprising:
storing, when a flag which is added to duplicate information including a transmission source address and a transmission destination address of a received packet and which indicates processing to the received packet is the specific flag, the flag in a first area in the first memory;
updating a value of a counter indicating an access frequency to duplicate information included in a second area at the first memory for each processing according to the received packet;
executing processing in the second area corresponding to each flag in the first area accumulated at a first timing;
referring to the second area for each processing at a second timing; and moving an entry in the second area from the first memory to a second memory provided at a subsequent stage of the first memory when the updated value of the counter is equal to or greater than a threshold.

14. The monitoring method of claim 13,
wherein the processor completes the processing relating to the first timing and starts the processing at the second timing when the number of entries in the first area becomes greater than or equal to a predetermined number.

15. The monitoring method of claim 13,
wherein the processor continues the processing at the first timing when the number of entries in the first area is less than a predetermined number.

16. The monitoring method of claim 13,
wherein the specific flag includes a flag defined by a communication protocol of a Transmission Control Protocol/Internet Protocol (TCP/IP) header.

17. The monitoring method of claim 13,
wherein the duplicate information further includes a transmission destination port number.

18. The monitoring method of claim 13,
wherein the duplicate information further includes a transmission source port number.
